(19) United States
(12) Patent Application Publication
(10) Pub. No.: US 2016/0190871 A1
(43) Pub. Date: Jun. 30, 2016

(54) POWER RECEIVING APPARATUS, METHOD OF CONTROLLING POWER RECEIVING APPARATUS, AND PROGRAM

(71) Applicant: CANON KABUSHIKI KAISHA, Ohta-ku, Tokyo (JP)

(72) Inventor: Hidetada Nago, Kawasaki-shi (JP)

(73) Assignee: Canon Kabushiki Kaisha, Tokyo (JP)

(21) Appl. No.: 14/910,239

(22) PCT Filed: Jul. 18, 2014
(86) PCT No.: PCT/JP2014/003833

§ 371 Date: Feb. 4, 2016

(30) Foreign Application Priority Data
Aug. 9, 2013 (JP) 2013-166398

(51) Int. Cl. H02J 50/10

(52) U.S. Cl. CPC H02J 50/10

(57) ABSTRACT

The present invention relates to a wireless power transmission system in which power transmission efficiency and safety go hand in hand. A power receiving apparatus includes a requesting unit configured to request power from a power transmitting apparatus; a detection unit configured to detect that the power transmitting apparatus has started transmission of the power requested by the requesting unit, an antenna configured to receive power wirelessly transmitted from the power transmitting apparatus, a load unit configured to operate using the power received through the antenna, and a switching unit configured to switch, in accordance with detection performed by the detection unit, a disconnected state in which the antenna and the load unit are disconnected from each other to a connected state in which the antenna and the load unit are connected to each other.

### TECHNICAL FIELD

The present invention relates to a wireless power transmission technology.

### BACKGROUND ART

Recent known technologies include a wireless power transmission system that includes a power transmitting apparatus which transmits power in a wireless (non-contact) manner without using a connector for connection and a power receiving apparatus which receives power supplied from the power transmitting apparatus. The power transmitting apparatus disclosed in PTL 1 employs a technique to enhance safety in wireless power transmission by limiting a current supplied to a power transmitting unit when an overcurrent state is detected, for example, in the case where excessive power is suddenly consumed or excessive power is required in a power receiving apparatus.

### CITATION LIST

### Patent Literature

[PTL 1]

Japanese Patent Laid-Open No. 2013-102666

### SUMMARY OF INVENTION

The present invention provides a power receiving apparatus including: a requesting unit configured to request power from a power transmitting apparatus; a detection unit configured to detect that the power transmitting apparatus has started transmission of the power requested by the requesting unit; an antenna configured to receive power wirelessly transmitted from the power transmitting apparatus; a load unit configured to operate using the power received through the antenna; and a switching unit configured to switch, in accordance with detection performed by the detection unit, a disconnected state in which the antenna and the load unit are disconnected from each other to a connected state in which the antenna and the load unit are connected to each other.

Further features of the present invention will become apparent from the following description of exemplary embodiments with reference to the attached drawings.

### BRIEF DESCRIPTION OF DRAWINGS

FIG. 1 is a diagram illustrating a configuration of a wireless power transmission system.

FIG. 2 is a diagram illustrating a configuration of a power transmitting apparatus.

FIG. 3 is a diagram illustrating a configuration of a power receiving apparatus.

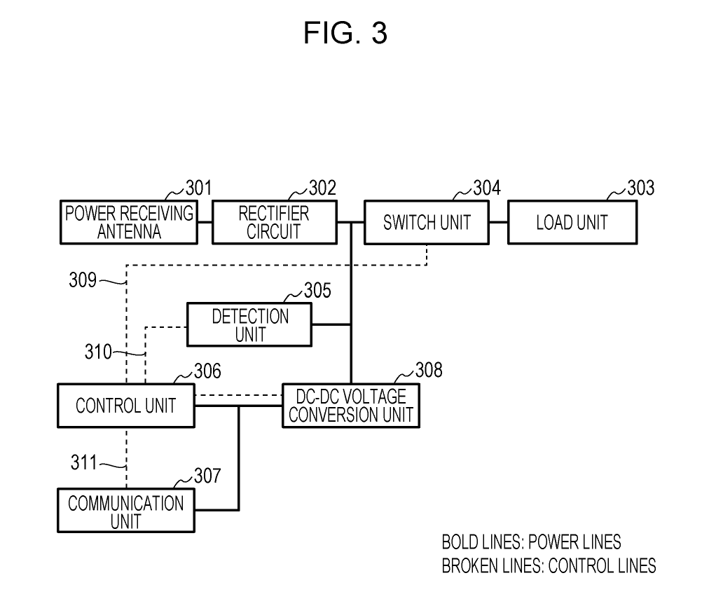

FIG. 4 is a sequence diagram of the wireless power transmission system.

FIG. 5 is a flowchart of the power receiving apparatus.

FIG. 6 is a diagram illustrating a voltage waveform detected by a detection unit of the power receiving apparatus.

### DESCRIPTION OF EMBODIMENTS

In a wireless power transmission system, while a power transmitting apparatus is transmitting power to a first power receiving apparatus, when a user places a second power receiving apparatus in a power transmission region of the power transmitting apparatus and the second power receiving apparatus starts to receive power before the power transmitting apparatus changes the power transmission output, the power transmitting apparatus may, at least temporarily, enter an overcurrent state. In such a case, when the power transmitting apparatus limits a current input to the power transmitting unit as in PTL 1, the first power receiving apparatus becomes unable to receive power at a desired power level, whereby the power transmission efficiency of the whole system will decrease. In view of the above problem, the embodiment below realizes a state in which power transmission efficiency and safety go hand in hand in a wireless power transmission system.

### First Embodiment

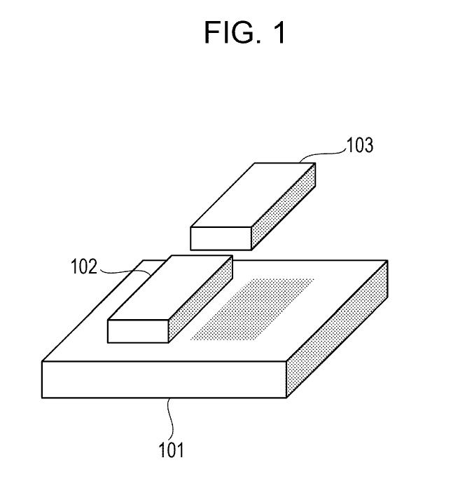

FIG. 1 is a diagram illustrating the configuration of a wireless power transmission system in the present embodiment. Note that the wireless power transmission system according to the present invention performs wireless power transmission using a magnetic resonance method. The magnetic resonance method is a method in which power is transmitted by means of magnetic resonance coupling between a resonator (resonant element) of a power transmitting apparatus and a resonator (resonant element) of a power receiving apparatus. Although an example of a wireless power transmission system using a magnetic resonance method is described in the present embodiment, a wireless power transmission system (non-contact power transmission method) is not limited this, and a power transmission method using electromagnetic induction, electric field resonance, microwaves, a laser, light, or the like may be used.

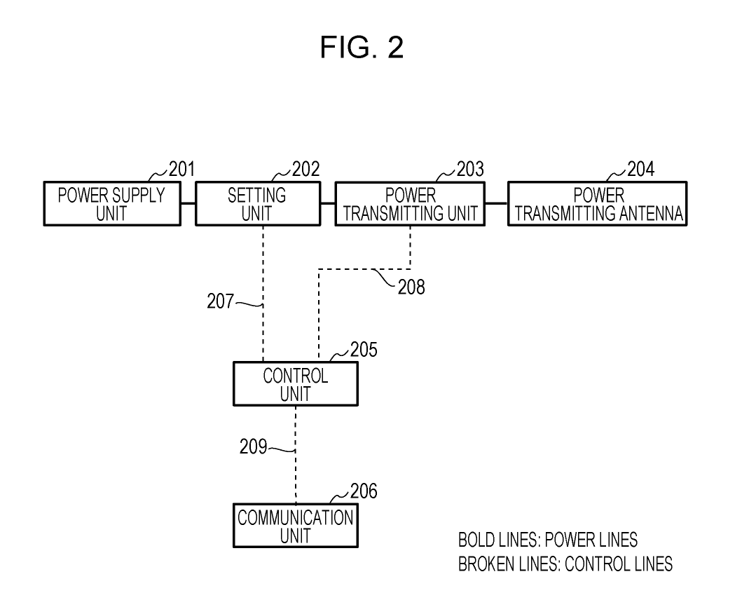

Referring to FIG. 1, reference numeral 101 denotes a power transmitting apparatus, reference numeral 102 denotes a first power receiving apparatus, and reference numeral 103 denotes a second power receiving apparatus. FIG. 2 illustrates the configuration of the power transmitting apparatus 101. Referring to FIG. 2, reference numeral 201 denotes a power supply unit that is connected to a battery of the power transmitting apparatus 101 or to an external power supply and that supplies power to the whole apparatus. Reference numeral 202 denotes a setting unit that sets an upper limit for the power transmitted by the power transmitting apparatus 101. The setting unit 202 limits an input voltage applied to the power transmitting unit 203 so that transmitted power does not exceed the set upper limit. The power transmitting unit 203 converts AC or DC power input from the setting unit 202 into AC power with a frequency in a transmission band, and transmits it to a power receiving apparatus through a power transmitting antenna 204.

Reference numeral 205 denotes a control unit that controls constituent units of the power transmitting apparatus 101. The control unit 205, which is formed of a central processing unit (CPU), performs power transmission processing through control of hardware components by executing stored control programs. Reference numeral 206 denotes a communication unit for wireless communication. The communication unit 206 sends and receives control signals for wireless power transmission to and from a power receiving apparatus. The communication unit 206 has a communication function conforming to, for example, the Bluetooth (registered trade mark) 4.0 specification. Note that the communication unit 206 may use other communication standards, which include, for example, a wireless LAN (IEEE 802.11 series) and Near-Field Communication (NFC). Reference numeral 207 denotes a control line for communicating control signals between the control unit 205 and the setting unit 202. Reference numeral 208 denotes a control line for communicating control signals between the control unit 205 and the power transmitting unit 203. Reference numeral 209 denotes a control line for communicating control signals between the control unit 205 and the communication unit 206.

Next, the configurations of the first power receiving apparatus 102 and the second power receiving apparatus 103 are illustrated in FIG. 2. In the figure, reference numeral 301 denotes a power receiving antenna for wirelessly receiving power from the power transmitting apparatus 101. Reference numeral 302 denotes a rectifier circuit for rectifying AC power received by the power receiving antenna 301 to obtain DC power. Reference numeral 303 denotes a load unit that operates with the received power. The load unit 303 may be, for example, a battery. Reference numeral 304 denotes a switch unit that switches connection between the rectifier circuit 302 and the load unit 303 on and off. The switch unit 304 switches a connection state between the power receiving antenna 301 and the load unit 303 from an unconnected state to a connected state. When the rectifier circuit 302 is connected to the load unit 303 through switching of the switch unit 304, power is supplied to the load unit 303. In an unconnected state, the load unit 303 does not operate since supply of power to the load unit 303 is stopped. In a connected state, the load unit 303 operates using power received through the antenna. Reference numeral 305 denotes a detection unit that detects a voltage between the rectifier circuit 302 and the switch unit 304.

Reference numeral 306 denotes a control unit that controls constituent units of the power receiving apparatus. The control unit 306 operates using power received through the power receiving antenna 301. The control unit 306, which is formed of a CPU, controls hardware units by executing a stored control program, thereby performing power receiving processing. Reference numeral 307 denotes a communication unit for wireless communication. The communication unit 307 sends and receives control signals for wireless power transmission to and from the power transmitting apparatus. The communication unit 307 operates using power received through the power receiving antenna 301. The communication unit 307 sends a message requesting power transmission together with the amount of requested power to the power transmitting apparatus. The communication unit 307 has a communication function conforming to, for example, the Bluetooth (registered trade mark) 4.0 specification. Note that the communication unit 307 may use other communication standards, which include, for example, a wireless LAN (IEEE 802.11 series) and Near-Field Communication (NFC). Reference numeral 308 denotes a DC-DC voltage conversion unit that converts the output of the rectifier circuit 302 into a voltage allowing the control unit 306 and the communication unit 307 to operate. Reference numeral 309 denotes a control line for communicating control signals between the control unit 306 and the switch unit 304, and reference numeral 310 denotes a control line for communicating control signals between the control unit 306 and the detection unit 305. Reference numeral 311 denotes a control line for communicating control signals between the control unit 306 and the communication unit 307.

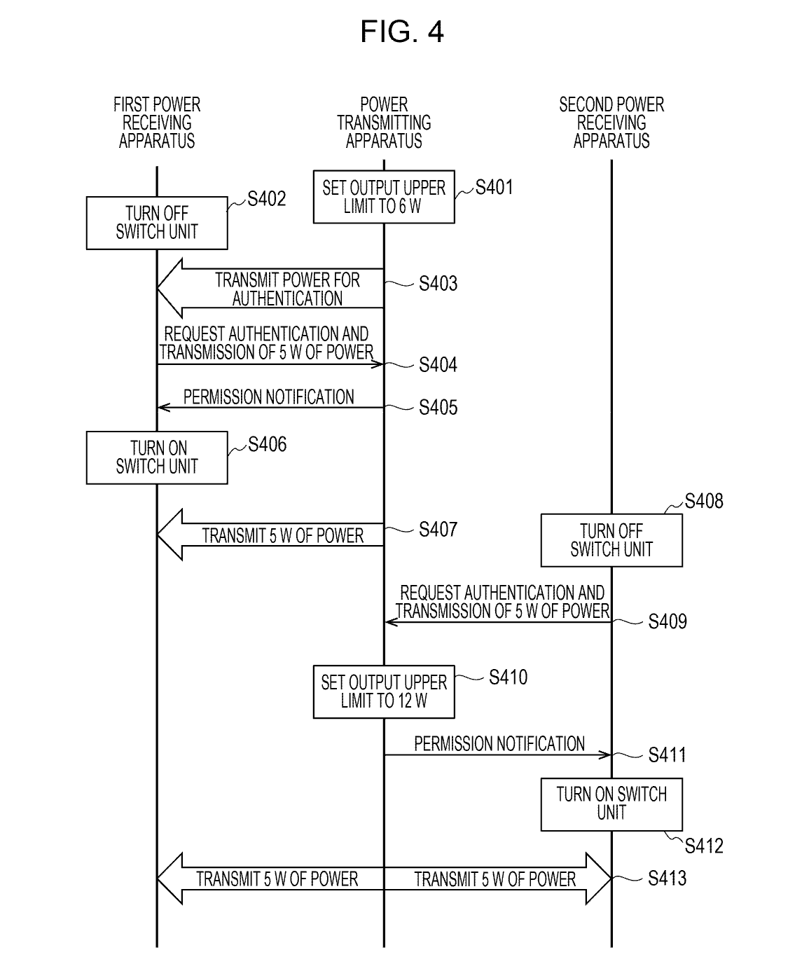

Next, the operation of a wireless power transmission system having the above-described configuration will be described with reference to FIGS. 4 to 6. Here, description will be made regarding the case in which while the power transmitting apparatus 101 is transmitting power to the first power receiving apparatus 102, power transmission to a second power receiving apparatus is started. FIG. 4 is a sequence diagram for the apparatuses in the wireless power transmission system of the present embodiment.

First, the power transmitting apparatus 101, after starting to operate, sets transmission power to an initially set transmission power (S401). For ease of explanation, it is assumed that the initially set transmission power is 6 W. The control unit 205 of the power transmitting apparatus 101 sets 6 W in the setting unit 202. The power transmitting unit 203 starts to transmit power for authentication necessary for the control unit 306 and the communication unit 307 to operate (S403). The first power receiving apparatus 102, after starting to operate, turns off the switch unit 304, thereby making the rectifier circuit 302 and the load unit 303 be disconnected from each other (S402). The first power receiving apparatus 102, when placed on the power transmitting apparatus 101, receives power for authentication, and supplies the received power to the control unit 306 and the communication unit 307.

The first power receiving apparatus 102 notifies the power transmitting apparatus 101 of a request for authentication using the communication unit 307 (S404). The request for authentication can be said to be a message requesting the power transmitting apparatus to transmit power. Request for authentication includes the amount of power requested to be transmitted. Note that a notification of the requested power may be sent at the same time as a request for authentication or after completion of the authentication. It is assumed for ease of explanation that power requested by the first power receiving apparatus 102 is 5 W and that a notification of a request for power is sent at the same time as the request for authentication.

The control unit 205 of the power transmitting apparatus 101, upon receipt of a request for authentication from a power receiving apparatus via the communication unit 206, performs authentication. In this authentication, for example, the power transmission and reception apparatuses communicate information regarding supported specifications for wireless power transmission to determine whether or not there are mutually corresponding specifications for wireless power transmission therebetween, and authentication is performed on the basis of the communicated information. Further, for example, the power transmitting and receiving apparatuses communicate information regarding respective powers that can be transmitted and received therebetween to determine whether or not the powers that can be respectively transmitted and received by them correspond to each other, and authentication is performed on the basis of the communicated information. Further, for example, the power transmitting and receiving apparatuses communicate information for negotiation regarding power to be transmitted and received therebetween, and authentication is performed on the basis of the communicated information.

The power transmitting apparatus 101 determines whether or not power transmission in accordance with the requested power can be performed under the current setting of the output upper limit. In this example, when 5 W is requested by the first power receiving apparatus 102 under an output upper limit of 6 W, it is determined that power transmission in accordance with the requested power can be performed under the current setting of the output upper limit. When it is determined that power transmission in accordance with the requested power cannot be performed under the current setting of the output upper limit, the output upper limit is re-set. Note that when the request for power received from the power receiving apparatus exceeds the capability of the power transmitting apparatus, rejection of authentication is transmitted to the power receiving apparatus.

The control unit 205 of the power transmitting apparatus 101 determines whether or not authentication is successful, and when it is determined that the authentication is successful, sends a power reception permission notification to the first power receiving apparatus 102 via the communication unit 206 as a response to the request for authentication (S405). Note that, when the authentication fails, the power transmitting apparatus 101 sends an authentication rejection notification as a response to the request for authentication.

The first power receiving apparatus 102, upon receipt of a power reception permission notification in response to the request for authentication, makes the switch unit 304 be in a connected state, determining that a modification of a transmission power output in response to the requested power has been detected (S406). It can be said that the power reception permission notification is information for instructing switching of the switch unit 304 to a connected state. The first power receiving apparatus 102 receives power transmitted from the power transmitting apparatus 101 and supplies the received power to the load unit 303 (S407).

It is assumed that, while the power transmitting apparatus 101 is transmitting power to the first power receiving apparatus 102, the second power receiving apparatus 103 starts a power receiving operation. The second power receiving apparatus 103, after starting to operate, turns off the switch unit 304, thereby making the rectifier circuit 302 and the load unit 303 be disconnected from each other (S408). The second power receiving apparatus 103, when placed on the power transmitting apparatus 101, receives part of the power being transmitted from the power transmitting apparatus 101, supplies the received power to the control unit 306 and the communication unit 307. The second power receiving apparatus 103 notifies the power transmitting apparatus 101 of a request for authentication using the communication unit 307 (S409). It is assumed for ease of explanation that power requested by the second power receiving apparatus 103 is 5 W and that a notification of the corresponding request for power is sent. The power transmitting apparatus 101, which has received the request for authentication, determines whether or not authentication for the second power receiving apparatus 103 is successful. The power transmitting apparatus 101 also determines whether or not power transmission in accordance with the received request for power can be performed under the current setting of an output upper limit. In this example, since 5 W of power is being transmitted to the first power receiving apparatus 102 under an output upper limit of 6 W, when 5 W of power requested by the second power receiving apparatus 103 is added, the output upper limit is exceeded. When it is determined that power transmission in accordance with the received request for power cannot be performed under the current setting of an output upper limit, the power transmitting apparatus 101 re-sets the current output upper limit (S410). In this case, the control unit 306 of the power transmitting apparatus 101 changes the setting in the setting unit 202 to a value (for example, 12 W) that allows a total of 10 W of power to be transmitted. Note that a notification of power reception termination is sent to the second power receiving apparatus 103 (S410). Note that when it is determined that power transmission in accordance with the received request for power cannot be performed under the current setting of an output upper limit, the power transmitting apparatus 101 may send a notification message to the power receiving apparatus, which requested power transmission, instructing not to start control for switching the switch unit 304 to a connected state.

The control unit 205 of the power transmitting apparatus 101, when transmission of requested power became possible by re-setting performed in the setting unit 202, sends a power reception permission notification to the second power receiving apparatus 103 via the communication unit 307 (S411). The second power receiving apparatus 103, upon receipt of the power reception permission notification, makes the switch unit 304 be in a connected state (S412). Then the power transmitting apparatus 101 starts power transmission also for the second power receiving apparatus 103, and the second power receiving apparatus 103 starts to receive 5 W of power from the power transmitting apparatus 101 (S413). Note that the power transmitting apparatus 101 periodically monitors the power transmission output and determines whether or not the set upper limit is appropriate. When the transmission power becomes less than or equal to a threshold corresponding to the output upper limit, it is checked whether or not any power receiving apparatuses exist using the communication unit 206. Then re-setting is performed to lower the output upper limit in accordance with the power receiving apparatus that has been determined to exist. This processing corresponds to the case in which a power receiving apparatus has been unexpectedly removed. Note that the power transmitting apparatus may perform re-setting to lower the output upper limit upon receipt of a power reception termination message from a power receiving apparatus.

As described above, a power receiving apparatus according to the present embodiment connects a power receiving antenna to a load circuit upon receipt of a power reception permission notification from a power transmitting apparatus. In other words, the occurrence of the power transmitting apparatus entering an overcurrent state is decreased since power receiving apparatuses start to increase power consumption in synchronization with the start of output of the power transmitting apparatus in consideration of power transmission to a new power receiving apparatus. Hence, since the power transmitting apparatus does not enter an overcurrent state, the occurrence of power transmission being stopped or output power being reduced is decreased, and the occurrence of power transmission efficiency being reduced in an apparatus which is already receiving power is decreased. In this manner, according to the wireless power transmission system of the present embodiment, safety is enhanced since the occurrence of the power transmitting apparatus entering an overcurrent state is decreased, and at the same time, since the occurrence of termination of power transmission or limiting output power is decreased, a decrease in transmission efficiency is reduced.

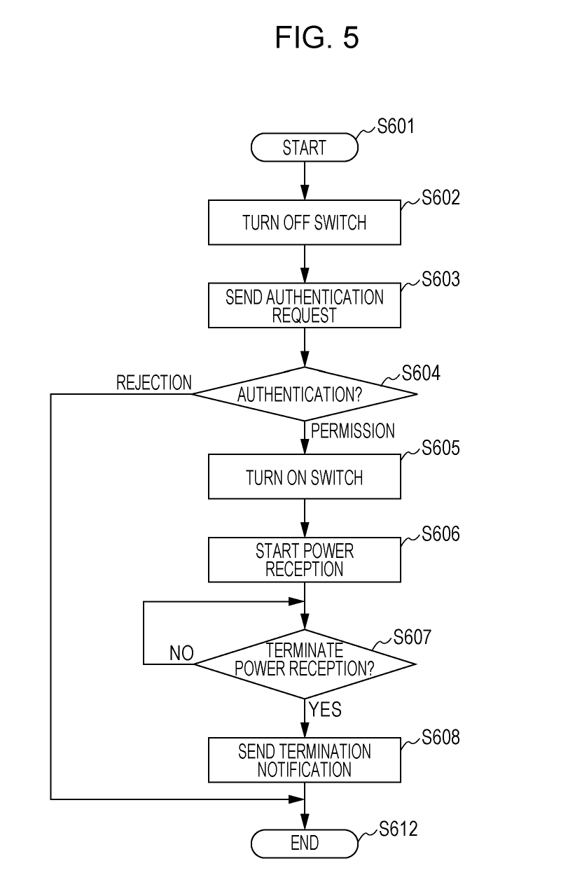

Next, the operation of the first power receiving apparatus 102 and the second power receiving apparatus 103 will be described with reference to a flowchart illustrated in FIG. 5. The power receiving apparatus, after starting to operate (S601), turns off the switch unit 304 and disconnects the rectifier circuit 302 from the load unit 303 (S602). Upon receipt of power through the power receiving antenna 301, supplies the received power to the control unit 306 and the communication unit 307. Then, the control unit 306 sends an authentication request including requested power to be supplied by the power transmitting apparatus to the power transmitting apparatus via the communication unit 307 (S603). The control unit 306 determines whether or not authentication performed by the power transmitting apparatus is successful on the basis of receipt of a notification of permission or a notification of failed authentication via the communication unit 307 (S604). When the authentication fails, the processing ends. When the authentication is successful, the control unit 306 through control of the communication unit 307, connects the rectifier circuit 302 and the load unit 303 to each other, and starts to supply received power to the load unit 303 (S605, S606). The control unit 306 determines whether or not power reception is to be terminated (S607). When it is determined that power reception is to be terminated, the control unit 306 sends a termination notification to the power transmitting apparatus and terminates the processing (S608, S609). Alternatively, the switch unit 304 may be turned off prior to the termination of the processing. With this operation, processing in step S602 can be omitted in the next power reception processing.

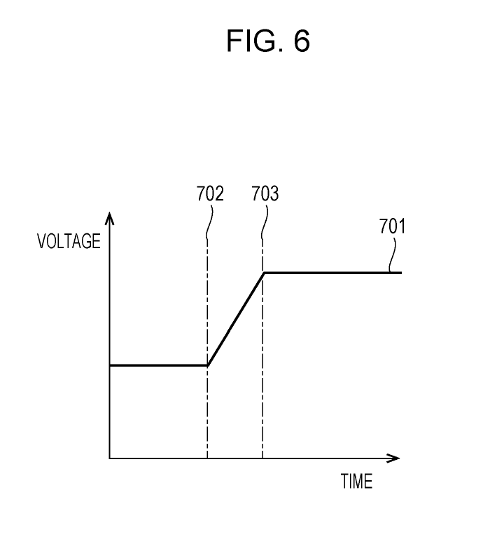

Note that in the description above, although the power receiving apparatus turns on/off the switch in response to receipt of a message from the power transmitting apparatus, the power receiving apparatus may start to receive power by detecting a change in the transmission power of the power transmitting apparatus. For example, the power receiving apparatus may turn on the switch unit 304 on the basis of the detection result obtained by the detection unit 305 of the second power receiving apparatus 103. Referring to FIG. 6, reference numeral 701 denotes the detection result obtained by the detection unit 305 versus time. In FIG. 6, reference numeral 702 denotes a point of time at which the power transmitting apparatus 101 starts to increase the power transmission output in response to a request from the power receiving apparatus. The detection unit 305 detects that the voltage has started to increase. As illustrated by a point of time 703, the voltage detected by the voltage detection unit 305 increases and stabilizes. As a result of the detection unit 305 detecting the increase in the voltage and stabilization of the voltage, it can be determined that the power transmitting apparatus 101 has changed the output upper limit. An exemplary case in which the control unit 306 and the communication unit 307 of the second power receiving apparatus 103 operate at 5 V and 20 mA will be described. Since the control unit 306 and the communication unit 307 of the second power receiving apparatus 103 consume 20 mA, when the power transmitting apparatus 101 increases the output by 5 W, the voltage detected by the detection unit 305 increases to 250 V. A configuration may be employed in which, when the voltage detected by the detection unit 305 becomes 250 V, it is determined that the changing of the output upper limit has been finished in the power transmitting apparatus 101, and reception of 5 W of power from the power transmitting apparatus 101 is started by controlling and turning on the switch unit 304.

Alternatively, a configuration may be employed in which, a period of time in which the power transmitting apparatus 101 is supposed to change the output upper limit is set and the second power receiving apparatus 103 starts to receive power after the predetermined period of time has elapsed.

According to the present embodiments, power transmission efficiency and safety go hand in hand.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-166398, filed Aug. 9, 2013 which is hereby incorporated by reference herein in its entirety.

1. A power receiving apparatus comprising:
a requesting unit configured to request power from a power transmitting apparatus;
a detection unit configured to detect that the power transmitting apparatus has started transmission of the power requested by the requesting unit;
an antenna configured to receive power wirelessly transmitted from the power transmitting apparatus;
a load unit configured to operate using the power received through the antenna; and
a switching unit configured to switch, in accordance with detection performed by the detection unit, a disconnected state in which the antenna and the load unit are disconnected from each other to a connected state in which the antenna and the load unit are connected to each other.

2. The power receiving apparatus according to claim 1, wherein the detection performed by the detection unit is performed on a basis of a response from the power transmitting apparatus to a request made by the requesting unit.

3. The power receiving apparatus according to claim 1, wherein the detection performed by the detection unit is performed on a basis of a voltage of an output of a rectifier circuit connected to the antenna.

4. The power receiving apparatus according to claim 1, wherein the requesting unit transmits a message requesting power transmission including an amount of requested power.

5. The power receiving apparatus according to claim 1, wherein the request made by the requesting unit is made using wireless communication.

6. The power receiving apparatus according to claim 1, wherein the request made by the requesting unit is made using power received through the antenna.

7. The power receiving apparatus according to claim 1, wherein the switching unit, when power reception is to be terminated, switches the connected state in which the antenna and the load unit are connected to each other to the disconnected state in which the antenna and the load unit are disconnected from each other.

8. The power receiving apparatus according to claim 1, wherein the load unit is not capable of operating in the disconnected state.

9. The power receiving apparatus according to claim 1, wherein, in the connected state, the load unit operates using the power received through the antenna.

10. A control method of controlling a power receiving apparatus comprising:
requesting power from a power transmitting apparatus;
detecting that the power transmitting apparatus has started transmission of the requested power; and
switching, in accordance with the detecting, a state in which an antenna configured to receive power wirelessly transmitted from the power transmitting apparatus and a load unit configured to operate using the power received through the antenna are disconnected from each other to a state in which the antenna and the load unit are connected to each other.

11. A non-transitory computer-readable storage medium storing a program for causing the power receiving apparatus to execute a control method comprising:
requesting power from a power transmitting apparatus;
detecting that the power transmitting apparatus has started transmission of the requested power; and
switching, in accordance with the detecting, a state in which an antenna configured to receive power wirelessly transmitted from the power transmitting apparatus and a load unit configured to operate using the power received through the antenna are disconnected from each other to a state in which the antenna and the load unit are connected to each other.
